(19) United States
(12) Patent Application Publication
(10) Pub. No.: US 2011/0066689 A1
(43) Pub. Date: Mar. 17, 2011

(54) REIMBURSEMENTS FOR ADVERTISEMENTS IN COMMUNICATIONS

(75) Inventors: Stefan Olsson, Lund (SE); Jonas Andersson, Menlo Park, CA (US); Minshik Roh, Palo Alto, CA (US); Martin Essl, San Francisco, CA (US); Ramanath Bhat, Mountain View (CA)

(73) Assignee: SONY ERICSSON MOBILE COMMUNICATIONS AB, Lund (SE)

(21) Appl. No.: 12/603,073

(22) Filed: Oct. 21, 2009

Related U.S. Application Data
(60) Provisional application No. 61/242,041, filed on Sep. 14, 2009.

(51) Int. Cl. G06F 15/16

(52) U.S. Cl. 709/206

(57) ABSTRACT

A device may include network interfaces for relaying communication information from source devices to destination devices and a processor. The processor may be configured to compare each of a plurality of advertisements to a part of the communication information, identify, within the communication information, a portion that matches one of the plurality of advertisements, and send a message that describes the identified advertisement to a reimbursement device.

### BACKGROUND

When a consumer communicates with others, the consumer may exchange information on particular products and/services. The information may include, for example, a picture of a particular product, a video clip (e.g., a commercial), trademarked names, an audio clip, text, logo, etc.

### SUMMARY

According to one aspect, a computer-readable medium may store computer-executable instructions, the computer-executable instructions including instructions for detecting, at a communication application, information exchanged with a peer device. Additionally, the computer-executable instructions may include instructions for comparing each of a plurality of advertisements to part of the information and identifying, within the information, a portion that matches one of the plurality of advertisements. Additionally, the computer-executable instructions may include instructions for sending data that describes the identified advertisement to a crediting device.

Additionally, the communication application may include at least one of a telephone application, an email application, a short message service (SMS) application, or an instant messaging (IM) application.

Additionally, the advertisement may include at least one of an image, text, a portion of a video stream, a portion of an audio stream, or a hyperlink that is associated with a product, a service, or a commercial entity.

Additionally, the computer-readable medium may further include instructions for receiving credits associated with the advertisement.

Additionally, the credit may include a cash credit, a purchase credit, or a discount coupon.

Additionally, the peer device may include one of a cellular telephone, a laptop, a personal computer, a personal digital assistant, a netbook, a gaming console, a digital camera, a video camera, a television, a set-top box, a digital video disk player, or an electronic notepad.

Additionally, the instructions for identifying the portion may include performing text recognition, image recognition, or speech recognition.

Additionally, the computer-readable medium may further include instructions for loading the plurality of advertisements into memory.

Additionally, the computer-readable medium may further include instructions for obtaining data that identifies a user action that is associated with the portion and sending the data that identifies the user action to the crediting device along with the data that describes the identified advertisement.

Additionally, the user action may include at least one of listening to the information, viewing the information, composting the information, receiving the information, or talking.

Additionally, the crediting device may include a second computer-readable medium. The second computer-readable medium may include second computer-executable instructions, the second computer-executable instructions including instructions for receiving the data and determining an amount of the credit.

According to another aspect, a device may include network interfaces for relaying communication information from source devices to destination devices and a processor. The processor may be configured to compare each of a plurality of advertisements to a part of the communication information and identify, within the communication information, a portion that matches one of the plurality of advertisements. Additionally, the processor may be configured to send a message that describes the identified advertisement to a reimbursement device.

Additionally, the processor may be further configured to receive credit from the reimbursement device.

Additionally, the advertisement may include at least one of: text, image, audio data, or video data.

Additionally, the communication information may include at least one of information exchanged in a communication session, an email message, or an instant message.

Additionally, the source devices may include a cellular telephone, a laptop, a personal computer, or a personal digital assistant.

Additionally, the processor may be further configured to receive user input that selects a set of the advertisements to be identified in the communication information or receive user input that selects a set of advertisers whose advertisements are to be identified in the communication information.

Additionally, the network interfaces may be further configured to receive data describing user actions that are associated with the communication information and include the data in the message.

Additionally, the portion may include an attachment, the attachment including text file, an audio file, or a video file.

According to yet another aspect, a system may include a user device and a reimbursement device. The user device may detect information that is exchanged with a peer device, compare each of a plurality of advertisements to part of the information, identify, within the information, a portion that matches one of the plurality of advertisements, and send data that describes the identified advertisement. The reimbursement device may receive the data that describes the identified advertisement from the user device, determine credit to be assigned to a user of the user device based on the data, and credit the user based on the determined credit.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 illustrates concepts described herein;

FIG. 2 is a diagram of an exemplary network in which the concepts described herein may be implemented;

FIG. 3 is a diagram of an exemplary user device of FIG. 2;

FIG. 4 is a block diagram of an exemplary network device of FIG. 2;

FIG. 5 is a block diagram of exemplary functional components of the user device of FIG. 2;

FIG. 6 is a block diagram of exemplary functional components of the reimbursement gateway of FIG. 2;

FIG. 7 is a block diagram of exemplary functional components of the reimbursement device of FIG. 2;

FIG. 8 is a flow diagram of an exemplary process that is associated with the user device of FIG. 2;

FIG. 9 is a flow diagram of an exemplary process that is associated with the reimbursement gateway of FIG. 2;

FIG. 10 is a flow diagram of an exemplary process that is associated with the reimbursement device of FIG. 2; and

FIG. 11 illustrates an example associated with providing reimbursements for advertisements in communications.

### DETAILED DESCRIPTION

The following detailed description refers to the accompanying drawings. The same reference numbers in different drawings may identify the same or similar elements. As used herein, the term “advertisement” may refer to information (e.g., text, image, audio, video, etc.) about a product, service, and/or commercial entity (e.g., brand name, trademark, business name, commercial, logo, URL of a company web site, etc.). The term “advertisement” may also refer to a reference or a link to an advertisement (e.g., a hyperlink to a web page that advertises a product). As used herein, the term “message” may refer to information that is sent or received in communication. A message may include not only text message, email message, etc., but also video stream, audio stream, and or other types of content.

In the following, a device may send or receive a message that includes an advertisement. When the devices receives and/or sends the message, the device may identify the advertisement within the message, may obtain data on user actions that are associated with the advertisement, and may send the identification and/or the data to a reimbursement gateway. In response, the reimbursement gateway may relay the received information to a reimbursement device that credits a user of the device.

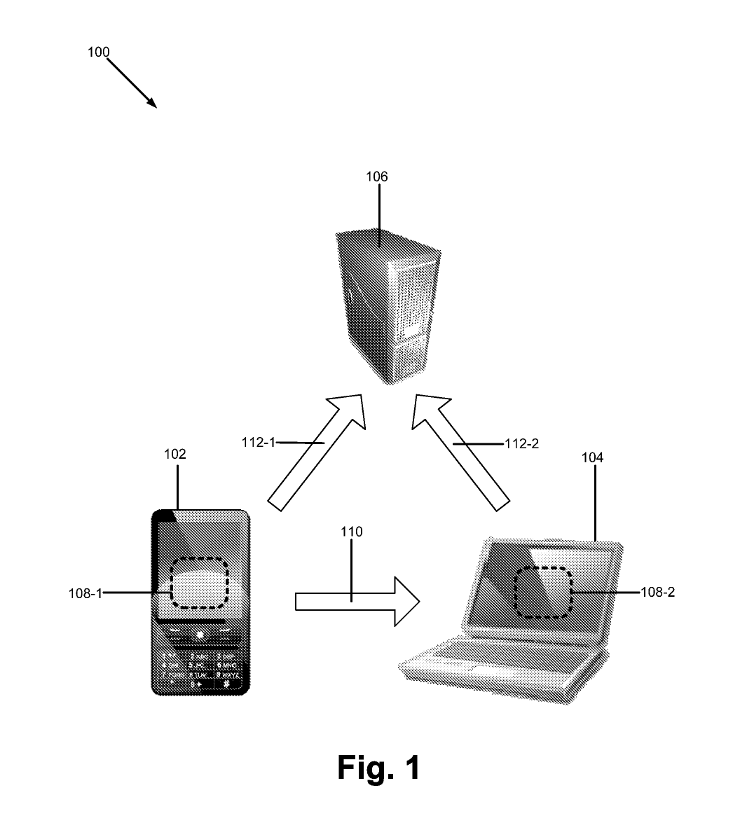

FIG. 1 illustrates the above concept. As shown, a system 100 may include a user device 102, user device 104, and a reimbursement device/gateway 106. When user device 102 sends a message 110 (e.g., an email, a SMS message, a voice mail, a phone call, etc.) to user device 104, applications 108-1 and/or 108-2 that are installed on user device 102 and 104, respectively, may examine message 110 to detect an advertisement. In addition, applications 108-1 and/or 108-2 may send information 112-1 and 112-2 to reimbursement device/gateway 106. In turn, reimbursement device/gateway 106 may facilitate crediting or may credit the user (e.g., give a discount, coupon, cash, etc.) for actions that are associated with the advertisement (e.g., compose or send a message that includes the advertisement).

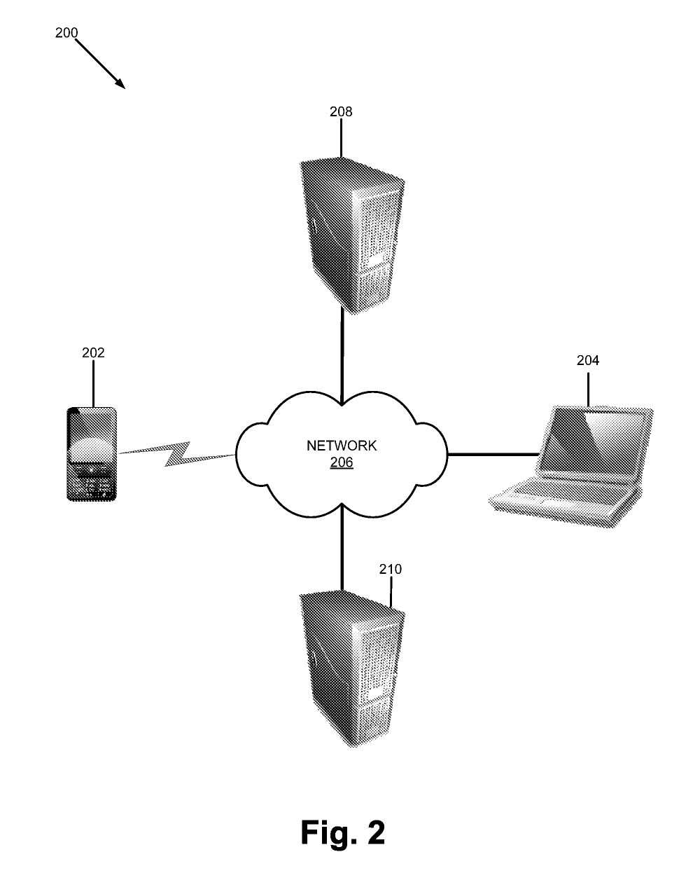

FIG. 2 is a diagram of an exemplary network 100 in which the concepts described herein may be implemented. As shown, network 100 may include user devices 202 and 204, a reimbursement gateway 208, and a reimbursement device 210. Depending on the implementation, network 100 may include additional, fewer, or different devices than the ones illustrated in FIG. 1. For example, in some implementations, network 100 may include hundreds, thousands, or more of user devices.

User devices 202 and/204 may send or receive messages. Further, in receiving or sending the messages, user devices 202 may identify advertisements that are included or embedded in the messages. As described below in greater detail, when an advertisement is identified, user device 202/204 may send data to reimbursement gateway 208 or reimbursement device 210 to obtain credit for certain user actions that are associated with the advertisement.

Network 206 may include a fiber-optic network (e.g., passive optical networks (PONs)), an ad hoc network, a local area network (LAN), a wide area network (WAN), a wireless LAN, a metropolitan area network (MAN), a cellular network, a public switched telephone network (PSTN), an intranet, the Internet, a satellite-based network, any other network, or a combination of networks. Devices that are shown in FIG. 2 may connect to network 206 via wireless, wired, or optical communication links. In addition, network 206 may allow any of devices 202-204 and 208-210 to communicate with any other device 202-204 and 208-210.

Reimbursement gateway 208 may relay identifications of advertisements and/or data about user actions that are associated with advertisements to reimbursement device 210. Reimbursement device 210 may receive the identifications and the data, determine credits that are due for each user device 202/204, and credit users of user devices 202 and 204.

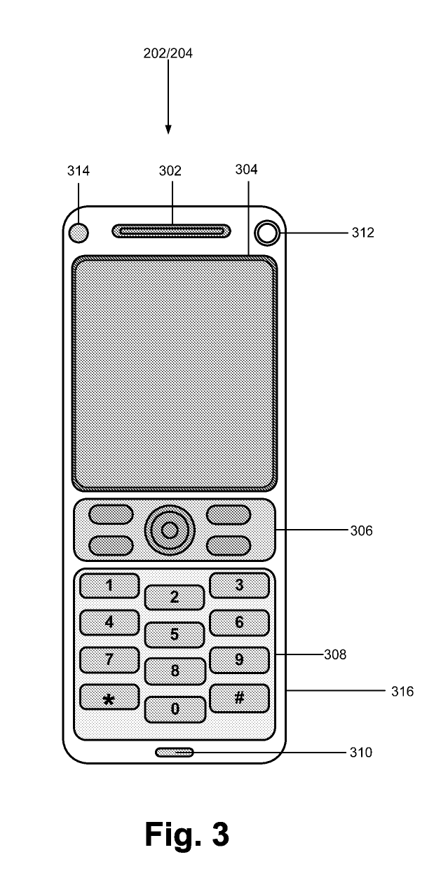

FIG. 3 is a diagram of an exemplary user device 202/204. User device 202/204 may include any of the following devices: a mobile telephone; a cellular phone; a personal communications system (PCS) terminal that may combine a cellular radiotelephone with data processing, facsimile, and/or data communications capabilities; an electronic notepad, a laptop, a netbook, an ultra mobile personal computer (UMPC), and/or a personal computer; a personal digital assistant (PDA) that can include a telephone; a gaming device or console; a peripheral (e.g., wireless headphone); a digital camera; or another type of computational or communication device.

In this implementation, user device 202/204 may take the form of a mobile phone (e.g., a cell phone). As shown in FIG. 3, user device 202/204 may include a speaker 302, a display 304, control buttons 306, a keypad 308, a microphone 310, sensors 312, a front camera 314, and a housing 316.

Speaker 302 may provide audible information to a user of user device 202/204. Display 304 may provide visual information to the user, such as an image of a caller, video images, or pictures. In addition, display 304 may include a touch screen for providing input to user device 202/204. Control buttons 306 may permit the user to interact with user device 202/204 to cause user device 202/204 to perform one or more operations, such as place or receive a telephone call. Keypad 308 may include a telephone keypad. Microphone 310 may receive audible information from the user. Sensors 312 may collect and provide, to user device 202/204, information (e.g., acoustic, infrared, etc.) that is used to aid the user in capturing images or in providing other types of information (e.g., a distance between a user and user device 202/204). Front camera 314 may enable a user to view, capture and store images (e.g., pictures, video clips) of a subject in front of user device 202/204. Housing 316 may provide a casing for components of user device 202/22/20 and may protect the components from outside elements.

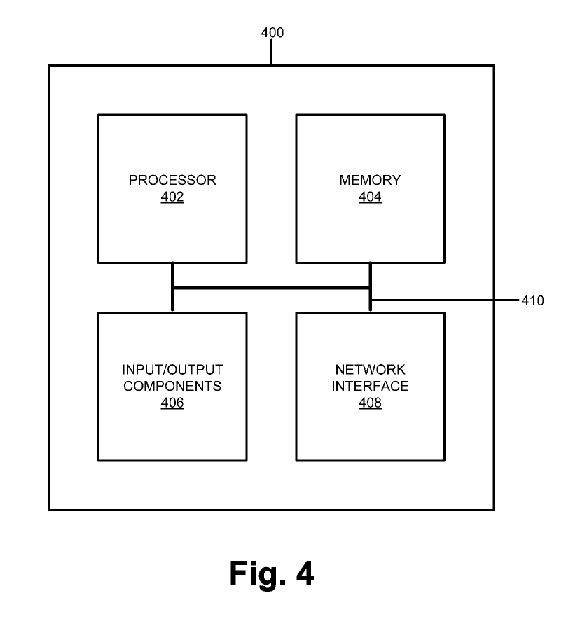

FIG. 4 is a block diagram of a network device 400, which may represent any of devices 202-204 and 208-210. As shown in FIG. 4, network device 400 may include a processor 402, a memory 404, input/output components 406, a network interface 408, and a communication path 410. In different implementations, device 400 may include additional, fewer, or different components than the ones illustrated in FIG. 4. For example, device 400 may include additional network interfaces, such as interfaces for receiving and sending data packets.

Processor 402 may include a processor, a microprocessor, an Application Specific Integrated Circuit (ASIC), a Field Programmable Gate Array (FPGA), and/or other processing logic (e.g., audio/video processor) capable of processing information and/or controlling network device 400. Memory 404 may include static memory, such as read only memory (ROM), and/or dynamic memory, such as random access memory (RAM), or onboard cache, for storing data and machine-readable instructions. Memory 404 may also include storage devices, such as a floppy disk, CD ROM, CD read/write (R/W) disc, and/or flash memory, as well as other types of storage devices.

Input/output components 406 may include a display screen (e.g., display 304, etc.), a keyboard, a mouse, a speaker, a microphone, a Digital Video Disk (DVD) writer, a DVD reader, Universal Serial Bus (USB) lines, and/or other types of components for converting physical events or phenomena to and/or from digital signals that pertain to network device 400.

Network interface 408 may include any transceiver-like mechanism that enables network device 400 to communicate with other devices and/or systems. For example, network interface 408 may include mechanisms for communicating via a network, such as the Internet, a terrestrial wireless network (e.g., a WLAN), a cellular network, a satellite-based network, a wireless personal area network (WPAN), etc. Additionally or alternatively, network interface 308 may include a modem, an Ethernet interface to a LAN, and/or an interface/connection for connecting network device 400 to other devices (e.g., a Bluetooth interface).

Communication path 410 may provide an interface through which components of network device 400 can communicate with one another.

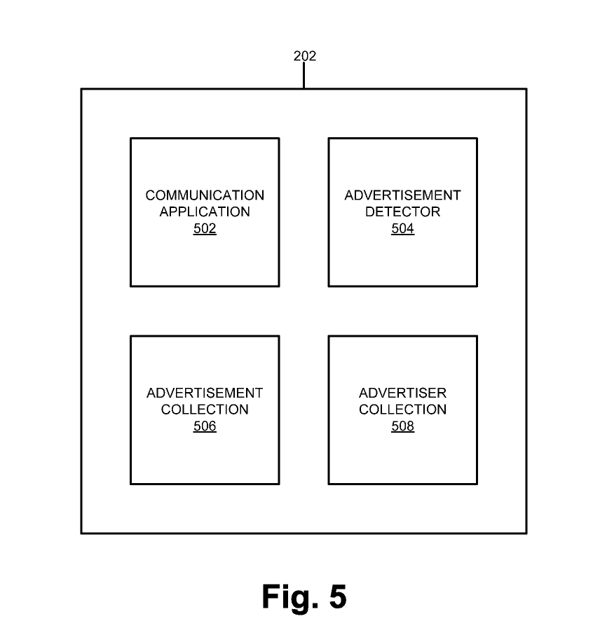

FIG. 5 is a block diagram of exemplary functional components of user device 202/204. As shown, user device 202/204 may include communication application 502, advertisement detector 504, advertisement collection 506, and/or advertiser detector 508. Depending on the implementation, user device 202/204 may include additional, fewer, or different functional components than those illustrated in FIG. 5. For example, user device 202/204 may include an operating system, document application, game application, etc.

Communication application 502 may include an application for communicating with another device. Examples of communication application 502 may include an email client, a short messaging service (SMS) client, an instant messaging application, a browser, etc.

Advertisement detector 504 may include software logic that is integrated into communication application 502, a plug-in, and/or a stand-alone application that is capable of detecting advertisements in a message (e.g., email message, a video clip or stream, an image, an audio clip or stream, etc.).

In detecting an advertisement, advertisement detector 504 may compare one or more of advertisements that are loaded in memory (e.g., memory 404) to content of the message (e.g., text, video stream, image, audio, etc.) and/or embedded information (e.g., images, videos, audio, files, links, etc.) in the communication. For example, advertisement detector 504 may scan for a specific text within an email (e.g., “Nike,” “Adidas,” etc.). In another example, advertisement detector 504 may analyze frames of a video stream to detect a logo that is associated with a particular brand (e.g., Sony Ericsson logo).

In addition, advertisement detector 504 may detect a user action that is associated with a message that includes an advertisement. For example, advertisement detector 504 may determine that a user has opened an email message and has “clicked” on a link that leads to a website for a particular product or company. In another example, when a user sends a message that includes a picture of a product, advertisement detector 504 may determine that user has “sent” a message that includes the advertisement. In yet another example, advertisement detector 504 may determine the amount of time the user has spent on a specific email message (e.g., 3 minutes). In each of the above cases, advertisement detector 504 may obtain data on user actions (e.g., “click,” “send,” “spend time,” etc.) that are associated with a message that includes an advertisement.

Once advertisement detector 504 identifies advertisements and obtains data about the user actions, advertisement detector 504 may send the identifications and the data to an advertiser (e.g., reimbursement device 210) that may credit the user or to an intermediary (e.g., reimbursement gateway 208) that may relay the information to the advertiser.

In some implementations, advertisement detector 504 may provide a graphical user interface (GUI) for reconfiguring advertisement detector 504. For example, advertisement detector 504 may include one or more options for selecting a specific set of advertisements that advertisement detector 504 may detect. The selection may be based on identities of advertisers, types of advertisement (e.g., video, image, text, link, etc.), and/or types of messages in which advertisements are to be detected. In another example, advertisement detector 504 may allow the user to select the specific type of credits that the user can receive (e.g., a discount coupons) and detect only advertisements from advertisers that provide such credits.

In some implementations, advertisement detector 504 may be implemented for a specific type of communication application 502. For example, in one implementation, advertisement detector 504 may be implemented as part of or as a plug-in to an email client. In such instances, types of user-configurable parameters may be limited by communication application 502 for which advertisement detector 504 is designed.

Advertisement collection 506 may include a collection of advertisements (e.g., text, image, audio clip, video clip, link, etc.) that advertisement detector 504 may load in memory 404 of user device 202/204. Once loaded, the advertisements may be used by advertisement detector 506 to determine whether the advertisements are included in communications to/from communication application 502. Advertisement collection 506 may be updated, over network 206, periodically or when user device 202/204 receives an update notification from another device (e.g., reimbursement gateway 208, reimbursement device 210, etc.).

In some implementations, advertisement collection 506 or part of advertisement collection 506 may be hosted on a remote device (e.g., reimbursement gateway 208, reimbursement device 210, etc.). In such implementations, advertisement detector 504 may load at least some of the advertisements from the remote device.

Advertiser collection 508 may include a list of advertisers that are associated with advertisement collection 506. For example, “Sony Ericsson” may be associated with a Sony Ericsson logo, and may be included in advertiser collection 508. In addition, for each advertiser, advertiser collection 508 may provide a network address (e.g., domain name, an IP address, a link, etc.) to which advertisement detector 504 can send advertisement identifications and/or data associated with user actions that are associated with the detected or identified advertisements. Advertiser collection 508 may be updated, over network 206, periodically or upon receiving a notification from a remote device.

In some implementations, a user may modify advertisement collection 506 and/or advertiser collection 508. For example, the user may cause, via a GUI for advertisement detector 504, advertisement collection 506 to store advertisements from only specific advertisers (e.g., Sony Ericsson, Nike, etc.). In another example, the user may store in advertisement collection 506 only advertisements that are text based, to decrease processing load that is associated with detecting image, video, and/or audio. In yet another example, the user may remove certain advertisers in advertiser collection 508 for other reasons.

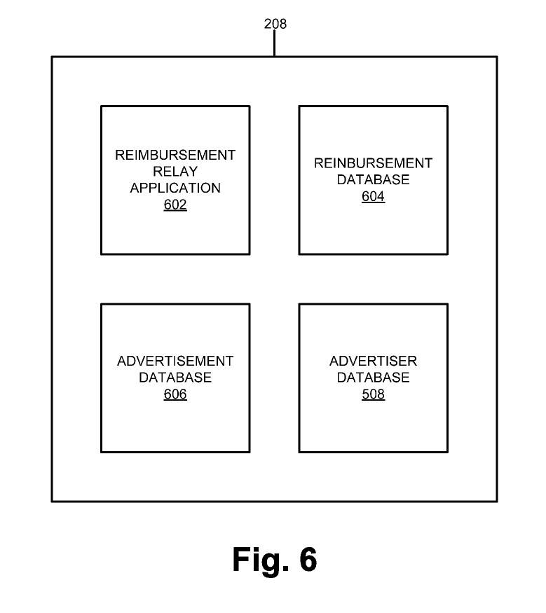

FIG. 6 is a block diagram of exemplary functional components of reimbursement gateway 208. As shown, reimbursement gateway 208 may include a reimbursement relay application 602, a reimbursement database 604, an advertisement database 606, and an advertiser database 608. Depending on the implementation, reimbursement gateway 208 may include additional, fewer, or different components than those illustrated in FIG. 6. For example, reimbursement gateway 208 may include an operating system, a server application (e.g., a web server), an email server, etc.

Reimbursement relay application 602 may relay information that is received from user device 202/204 to reimbursement device 210. In addition, reimbursement relay application 602 may obtain disbursement information from reimbursement device 210. Reimbursement database 604 may store reimbursement information and/or disbursement information for users. For example, reimbursement database 604 may record an amount of credit that is due a user or is received from reimbursement device 210. This information may be used by another component to credit the user and/or other entities (e.g., an entity that manufactures user device 202/204, an entity that licenses the functional components of user device 202/202, such as advertisement detector 504, advertisement database 506, etc.). Reimbursement database 604 may receive the reimbursement information from reimbursement device 210.

Advertisement database 606 may include a database of advertisements (e.g., text, image, audio clip, video clip, link, etc.) that may be used to update advertisement collection 506 on user device 202/204. Advertisement database 606 may periodically receive advertisements from reimbursement devices 210 of different advertisers. In a different implementation, user device 202/202 may receive advertisement updates directly from reimbursement devices 210, and reimbursement gateway 208 may not include advertisement database 608.

Advertiser database 608 may include a database of advertisers that may be used to update advertiser collection 508 on user device 202/204. Advertiser database 608 may be updated by a system administrator, a program, or another device.

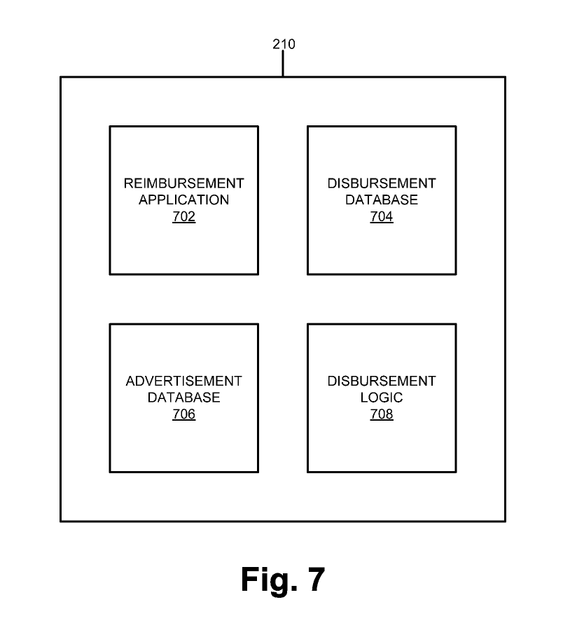

FIG. 7 is a block diagram of exemplary functional components of reimbursement device 210. As shown, reimbursement device 210 may include a reimbursement application 702, a disbursement database 704, an advertisement database 706, and disbursement logic 708. Depending on the implementation, reimbursement device 210 may include additional, fewer, or different components than those illustrated in FIG. 7. For example, reimbursement device 210 may include an operating system, a firewall, a web server, etc.

Reimbursement application 702 may determine, based on an identification of advertisement and data on user actions that are associated with the advertisement, determine an amount of credit that is due to the user. Reimbursement application 702 may store the result of such determination in disbursement database 704.

Disbursement database 704 may include records of occurrences of advertisements in messages, user actions that are associated with the advertisements, and credits that are due for the user actions. Although disbursement database 704 is shown as being included in reimbursement device 210, in a different implementation, disbursement database may be part of another device, such as a database for financial information of the advertiser (not shown).

Advertisement database 706 may include a database of advertisements (e.g., text, image, audio clip, video clip, link, etc.) that are specific to an advertiser. Advertisement database 706 may be used to update advertisement collection 506 on user device 202/204 and/or advertisement database 606 on reimbursement gateway 208. The advertiser may add or remove new advertisements to advertisement database 706.

Disbursement logic 708 may include hardware and/or software for crediting user actions that are associated with advertisements. Depending on the implementation, disbursement logic 708 may route credits directly to user devices 202/204 or to reimbursement gateway 208. Although disbursement logic 708 is shown as a component of reimbursement device 210, in a different implementation, disbursement logic 708 may be part of another device or component (e.g., a program for paying vendors).

In FIGS. 5-7, functional components 502-508, 602-608, and 702-708 may be distributed over user device 202/204, reimbursement gateway 208, and reimbursement device 210 such that advertisement identification or processing may be primarily performed at user device 202/204 and crediting function may be primarily performed at reimbursement device 210. Reimbursement gateway 208 may relay information between user device 202/204 and reimbursement device 210 to facilitate advertisement reimbursements.

In different implementations, functional roles of user device 202/204, reimbursement gateway 208, and reimbursement gateway 210 may be rearranged. For example, in one implementation, reimbursement gateway 208 may perform advertisement identification. In such implementations, user device 202/204 may send messages to other user devices via reimbursement gateway 208 and send information about user actions to reimbursement gateway 208. Upon receipt of the messages, reimbursement gateway 208 may identify advertisements that are carried by the messages.

In these implementations, user device 202/204 may not include advertisement collection 506 and/or advertiser collection 508. In addition, reimbursement gateway 208 may aggregate several transactions before sending the identified advertisements and their associated user actions to reimbursement device 210. In some variants of these implementations, reimbursement gateway 208 may perform additional processing, such as determining a credit that is due for each advertisement and an associated user action. In such implementations, reimbursement gateway 208 may not send advertisement identifications and/or corresponding data on user actions to reimbursement device 210.

In another example illustrating different arrangements of functional components 502-508, 602-608, and 702-708 in user device 202/204, reimbursement gateway 208, and reimbursement device 210, user device 202/204 may communicate directly with reimbursement device 210 to obtain credit. In some variations of this implementation, reimbursement device 210 may perform advertisement identification. Accordingly, user device 202/204 may not include advertisement collection 506 and/or advertiser collection 508.

### Exemplary Processes for Advertisement Reimbursements

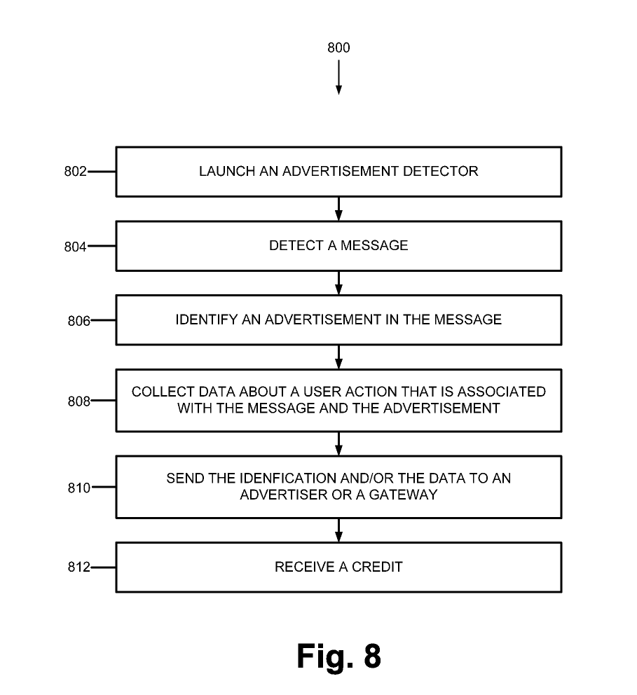

FIG. 8 is a flow diagram of an exemplary process 800 that is associated with user device 202/204. Process 800 may begin with launching or starting advertisement detector 504 in user device 202/204 (block 802). Advertisement detector 504 may start, for example, when a user launches advertisement detector 504 by activating a menu item or when advertisement detector 504 is launched automatically, e.g., as a plug-in along with communication application 502. Starting advertisement detector 504 may load some or all of advertisements in advertisement collection 506 into memory 404 of user device 202/204.

Communication application 502 and/or advertisement detector 504 may detect a communication message (block 804). For example, communication application (e.g., email application) and/or advertisement detector 504 may detect a receipt of an email message.

Advertisement detector 504 may identify or detect an advertisement in the detected message (block 806). For example, advertisement detector 504 may scan the message (e.g., an audio clip, phone call, email message, etc.) to detect an advertisement. More particularly, for example, advertisement detector 504 may scan for the words “Sony Ericsson” in an email message. In another example, advertisement detector 504 may scan for embedded objects or information, such as a URL, an image, a video clip, an audio clip, etc. In detecting the embedded information, advertisement detector 504 may first filter or isolate the embedded objects/information and determine whether it corresponds one of the advertisements in advertisement collection 506.

In determining whether content of the message or the embedded information includes an advertisement, advertisement detector 504 may apply a specific image/speech/sound detection scheme. For example, advertisement detector 504 may apply a translation- or rotation-invariant image detection algorithm to the message. Other pattern and/or information identifying schemes may be used to detect the advertisement.

Advertisement detector 504 may collect data about a user action that is associated with the advertisement and the message (block 808). Communication application 502 and/or advertisement detector 504 may track user actions for each message that communication application 502 processes. For example, assume that an email application has received a message. When a user views the message by clicking on a message item shown on a GUI window, communication application 502/advertisement detector 504 may store the user action as “mouse click.” Consequently, advertisement detector 504 may collect data that describes the mouse click. The data may be associated with the advertisement and/or the message.

In another example, assume that the user composes a message that includes text “Sony Ericsson.” Consequently, communication application 502 and/or advertisement detector 504 may store data that describes the user action “compose” and is associated with the message. When the user sends the message, advertisement detector 504 may store data that describes “sending a message” and is associated with the same message and the advertisement.

Examples of other user actions may include “listening” (e.g., listening to an audio clip), “talking” (e.g., pronouncing a word in a phone conversation), “linking” (e.g., inserting a hyperlink into a message), “inserting” (e.g., inserting an image into a message), etc. In some instances, no user action may be associated with a message or advertisement (e.g., a user does not read an incoming message that includes an advertisement).

Advertisement detector 504 may send the identification and/or the data to reimbursement gateway 208 and/or reimbursement device 210 (block 810). In some implementations, advertisement detector 504 may aggregate the identifications and/or the data over several messages to increase communication efficiency.

Advertisement detector 504 may receive credit for the identified advertisement and the user action associated with the advertisement (block 812). Depending on the implementation, advertisement detector 504 may receive credit from either reimbursement gateway 208 or reimbursement device 210. In some implementations, the credit may be in the form of a discount or a coupon that is associated with a product from the advertiser. In other implementations, the credit may be received in the form of cash to a user's bank account. For such implementations, the user may input the bank account information to advertisement detector 504 when the user configures advertisement detector 504.

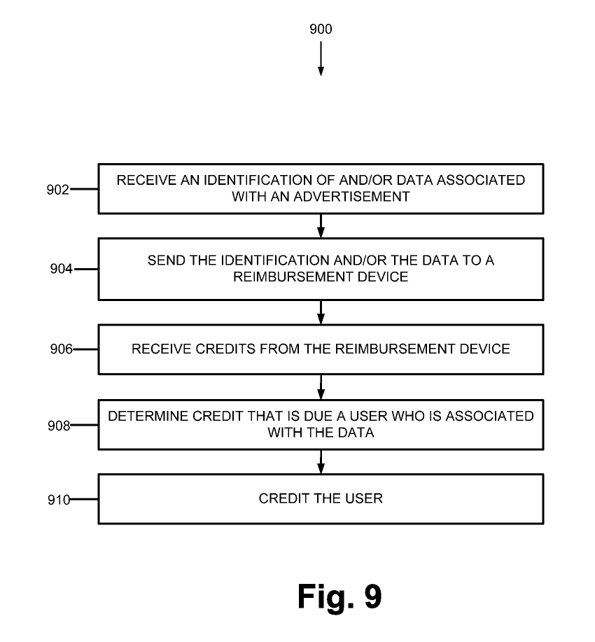

FIG. 9 is a flow diagram of an exemplary process 900 that is associated with reimbursement gateway 208. Process 900 may start when reimbursement relay application 602 receives an identification of an advertisement and/or data associated with the advertisement (block 902).

In response to the identification and the data, reimbursement relay application 602 may send the identification and the data to reimbursement device 210 (block 904). In sending the identification and the data, reimbursement relay application 602 may perform a lookup of an advertiser of the identified advertisement in advertiser database 608.

Reimbursement relay application 602 may receive credits from reimbursement device 210 (block 908). When reimbursement device 210 receives the identification and the data, reimbursement device 210 may determine credit that is due for a user action that is associated with the identified advertisement.

In some implementations, reimbursement relay application 602 may receive a single credit in the form of cash. In other implementations, reimbursement relay application 602 may receive credit due a user (e.g., in the form of discount or a purchase credit) as well as separate credit (e.g., in the form of cash) to another entity (e.g., a company that operates reimbursement gateway 208).

Reimbursement relay application 602 may determine credit that is due a user of user device 202/204 that sent the data (block 908). In one implementation, once a credit is received from reimbursement device 210, reimbursement relay application 602 may perform additional calculations in order to debit, from the received credit, amounts that are due other entities. For example, if a company that operates reimbursement gateway 208 is due credit for licensing communication application 502 and/or advertisement detector 504 to the user, reimbursement relay application 602 may deduct a corresponding amount from the received credit.

Reimbursement relay application 602 may credit the user (block 910). In some implementations, in crediting the user, reimbursement relay application 602 may provide the credit in the form of a discount coupon (e.g., an e-coupon) for products of the advertiser or a purchase credit.

Above, although blocks 902-910 are described as being performed by reimbursement relay application 602, in different implementations, blocks 902-910 may be performed by different functional components (not shown) that are hosted on reimbursement gateway 208 or a different device. For example, crediting the user may involve a financial application that is hosted on another device.

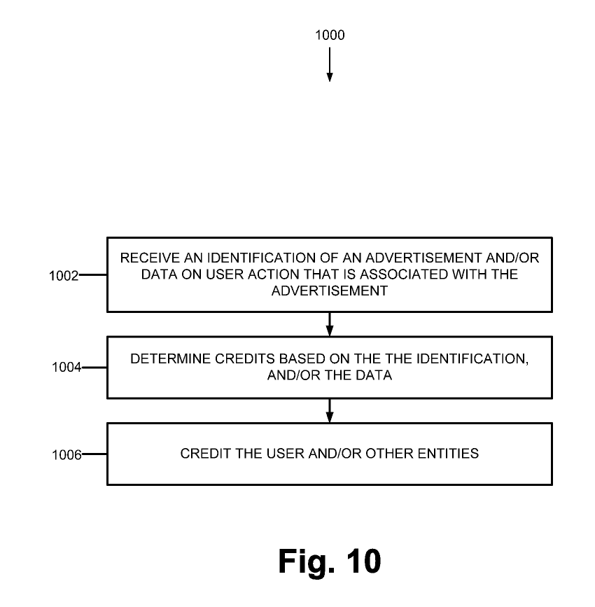

FIG. 10 is a flow diagram of an exemplary process that is associated with reimbursement device 210. Process 1000 may start with reimbursement application 702 receiving an identification of an advertisement and data about user action that is associated with the advertisement (block 1002).

Reimbursement application 702 may determine credits based on the advertisement identification and the data (block 1004). For example, assume that reimbursement application 702 has received an identification of the words “Sony Ericsson” and data that describes a user action “composing a message.” Accordingly, reimbursement application 702 may determine that the user who composed the message is due $0.02 and a company that operates reimbursement gateway 208 is due $0.01. In some implementations, reimbursement application 702 may store information on the credits in disbursement database 704.

Disbursement logic 708 may credit the user and/or other entities that are involved in providing reimbursements for the advertisement (block 1006).

### Example

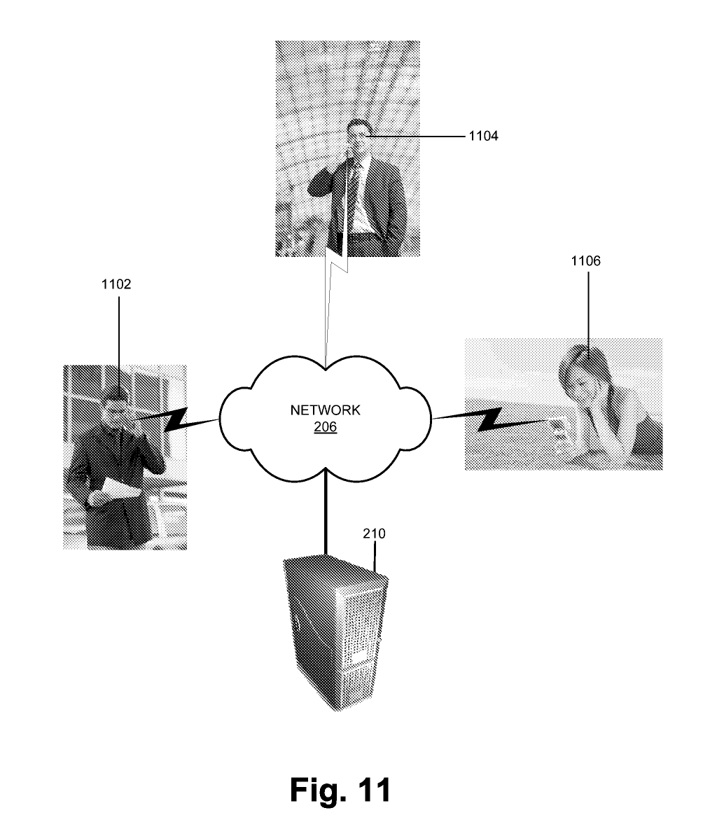

FIG. 11 illustrates an example that is associated with reimbursements for advertisements in communications. The example is consistent with the above descriptions. Assume that Stefan 1102, Johan 1104, and Rebecca 1106 are talking to each other in a conference call using their cellular phones over network 206.

Stefan 1102 and Jonas 1104 discuss purchasing “Sony Ericsson telephones” to Rebecca 1106. When Stefan 1102 and Jonas 1104 mention “Sony Ericsson” telephones, communication application 502 and/or advertisement detector 504 in Stefan, Jonas, and Rebecca's cellular phones detect the words “Sony Ericsson” as an advertisement. In addition, advertisement detector 504 in Stefan and Jonas's cellular phones associate the words with a user action “talking” Advertisement detector 504 in Rebecca's cellular phone associates the words with a user action “listening.”

Consequently, advertisement detectors 504 in Stefan, Jonas, and Rebecca's cell phones send the identification of “Sony Ericsson” and data that describes user actions (e.g., “talking” and “listening”) to reimbursement device 210. When reimbursement device 210 receives the identifications and the data, reimbursement device 210 determines credits that are due Stefan 1102, Jonas 1104, and Rebecca. 1106, and credits Stefan 1102, Jonas 1104, and Rebecca 1106 in the form of purchase credits.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, in place of user device 204, another server (e.g., a blog server) may receive messages from user device 202. In one scenario, a user may use user device 202 to capture and upload a video stream to the blog server. When the blog server receives the video stream, the blog server may detect advertisements (e.g., a logo, an image of a particular product, etc.) and send information to reimbursement device 210 to provide credits to appropriate users/entities.

In another example, while series of blocks have been described with regard to the exemplary processes illustrated in FIGS. 8-10, the order of the blocks may be modified in other implementations. In addition, non-dependent blocks may represent acts that can be performed in parallel to other blocks. Further, depending on the implementation of functional components, some of the blocks may be omitted from one process (e.g., process 800) and similar blocks may be added to another process (e.g., process 900).

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computer-readable medium for storing computer-executable instructions, the computer-executable instructions comprising instructions for:
detecting, at a communication application, information exchanged with a peer device;
comparing each of a plurality of advertisements to part of the information;
identifying, within the information, a portion that matches one of the plurality of advertisements; and
sending data that describes the identified advertisement to a crediting device.

2. The computer-readable medium of claim 1, wherein the communication application includes at least one of: a telephone application, an email application, a short message service (SMS) application, or an instant messaging (IM) application.

3. The computer-readable medium of claim 1, wherein the advertisement includes at least one of:
an image, text, a portion of a video stream, a portion of an audio stream, or a hyperlink that is associated with a product, a service, or a commercial entity.

4. The computer-readable medium of claim 1, further comprising instructions for receiving credits associated with the advertisement.

5. The computer-readable medium of claim 4, wherein the credit includes:
a cash credit, a purchase credit, or a discount coupon.

6. The computer-readable medium of claim 1, wherein the peer device includes one of: a cellular telephone, a laptop, a personal computer, a personal digital assistant, a netbook, a gaming console, a digital camera, a video camera, a television, a set-top box, a digital video disk player, or an electronic notepad.

7. The computer-readable medium of claim 1, wherein the instructions for identifying the portion includes performing text recognition, image recognition or speech recognition.

8. The computer-readable medium of claim 1, further comprising instructions for:
loading the plurality of advertisements into memory.

9. The computer-readable medium of claim 1, further comprising instructions for:
obtaining data that identifies a user action that is associated with the portion; and
sending the data that identifies the user action to the crediting device along with the data that describes the identified advertisement.

10. The computer-readable medium of claim 9, wherein the user action includes at least one of: listening to the information, viewing the information, composting the information, receiving the information, or talking.

11. The computer-readable medium of claim 1, wherein the crediting device includes a second computer-readable medium, the second computer-readable medium including second computer-executable instructions, the second computer-executable instructions including instructions for:
receiving the data; and
determining an amount of the credit based on the data.

12. A device comprising:
network interfaces for relaying communication information from source devices to destination devices;
a processor to:
compare each of a plurality of advertisements to a part of the communication information;
identify, within the communication information, a portion that matches one of the plurality of advertisements; and
send a message that describes the identified advertisement to a reimbursement device.

13. The device of claim 12, wherein the processor is further configured to:
receive credit from the reimbursement device.

14. The device of claim 12, wherein the advertisement includes at least one of: text, image, audio data, or video data.

15. The device of claim 12, wherein the communication information includes at least one of:
information exchanged in a communication session, an email message, or an instant message.

16. The device of claim 12, wherein the source devices include:
a cellular telephone, a laptop, a personal computer, or a personal digital assistant.

17. The device of claim 12, wherein the processor is further configured to:
receive user input that selects a set of the advertisements to be identified in the communication information; or
receive user input that selects a set of advertisers whose advertisements are to be identified in the communication information.

18. The device of claim 12, wherein the network interfaces are further configured to:
receive data describing user actions that are associated with the communication information; and
include the data in the message.

19. The device of claim 12, wherein the portion includes an attachment, the attachment including text file, an audio file, or a video file.

20. A system comprising:
a user device to:
detect information that is exchanged with a peer device,
compare each of a plurality of advertisements to part of the information,
identify, within the information, a portion that matches one of the plurality of advertisements, and
send data that describes the identified advertisement; and
a reimbursement device to:
receive the data that describes the identified advertisement from the user device,
determine credit to be assigned to a user of the user device based on the data, and
credit the user based on the determined credit.
